(19) United States
(12) Patent Application Publication
(10) Pub. No.: US 2007/0078809 A1
(43) Pub. Date: Apr. 5, 2007

(54) Robust data availability system having decentralized storage and multiple access paths

(75) Inventors: Marc D. Semkow, Burnaby (CA); Clifton H. Bromley, New Westminister (CA); Eric G. Dorgelo, Port Moody (CA); Kevin G. Gordon, Annacis Island Delta (CA); Douglas J. Reichard, Fairview, OH (US); Shafin A. Virji, Vancouver (CA)

Correspondence Address: ROCKWELL AUTOMATION, INC./(AT), ATTENTION: SUSAN M. DONAHUE, 1201 SOUTH SECOND STREET, MILWAUKEE, WI, 53204, US

(73) Assignee: Rockwell Automation Technologies, Inc., Mayfield Heights, OH (US)

(21) Appl. No.: 11/239,823

(22) Filed: Sep. 30, 2005

(51) Int. Cl. G06F 17/30

(52) U.S. Cl. 707/2

(57) ABSTRACT

Architecture that provides high availability (quick, robust, redundant) data to users by the use of peer-to-peer technology, where the decentralized storage and multi-access paths provide the complete data set without dependence on a specific or pre-defined data source or access paths, including sourcing data from other users of the data applying the large file transfer techniques of file sharing. When a client requests a file the system automatically calculates all the locations of that file, and which is the quickest source to retrieve the file. The client then stores a copy of the file for instant retrieval later and to serve that file out to other clients that request it. A versioning scheme ensures that the only the newest version of files are shared on the network. A machine learning and reasoning component is provided that employs a probabilistic and/or statistical-based analysis to prognose or infer an action that a user desires to be automatically performed.

### TECHNICAL STATEMENT

This invention is related to data storage, and more specifically, to distributed and decentralized data storage techniques.

### BACKGROUND

With advances in computing, such systems are employed in many aspects of communications, industrial control, and industry, in general. As manufacturing becomes more complex and specialized, computing systems and the data and software programs utilized to monitor and control these processes are essential. Downtime related to hardware and/or software failure becomes crucial in terms of cost, lost productivity, and output.

Manufacturing control and monitoring systems consist of and produce enormous amounts of data. This includes configuration data such as controller code, and alarm, HMI (human-machine interface) data, recipe and report definitions, to name just a few. Additionally, while running, control systems produce both real-time and historical data about the status of a given process including alarms, process values, and audit/error logs. For example, process control workstation displays can show the current state of process variables to an operator. Additionally, historical trend objects can display historical data from a persistent store such as a database or log file. For example, trend object users can “pan” backwards in time in a line graph plotting some process variable against time to instances of the process variable that were captured (and stored) at some point in history. (e.g., “last week”).

In typical distributed HMI systems the data is stored in a predefined location(s). HMI displays themselves—typically in the form of process overviews or machine detail displays—can show real-time (or last known) values to an operator. Multiple screens are created so that the operator can switch between them to view aspects of the system under control. Thus, these monitor and control screens that link to inputs and outputs for monitor and control of processes are important. Additionally, the data provided by such screens needs to be stored for later retrieval.

Typically, users are responsible for backing up and deploying the data files. Each client must have a network path to the data, and the server serving the data must be available and functioning. If the server is on a low-bandwidth path to a client or a set of clients, performance will suffer. Moreover, when the server is the central storage location, multiple remote system failures can burden the server during file and/or software retrieval, especially for large production control files and software. Thus, alternative mechanism for the safeguard and retrieval of such data is imperative for continued operation of such key systems.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject innovation is architecture that provides high availability (quick, robust, redundant) data to users by the use of peer-to-peer technology, where the decentralized storage and multi-access paths provide the complete data set without dependence on a specific or pre-defined data source or access paths, including sourcing data from other users of the data applying large file transfer techniques of file sharing.

By using peer-to-peer technology to distribute files, a number of benefits are realized in a distributed HMI (human-machine interface) system. Files are distributed for storage on many computers eliminating a single point of failure. Additionally, client call-up times of requested data are reduced as the peer-to-peer technology retrieves the data from the quickest source. Since the files can be are stored in many different locations, data transfer bottlenecks that can occur on a network (e.g., LAN, WAN, WLAN, . . . ) can be eliminated. Moreover, large files can be retrieved from multiple sources at the same time eliminating the single source bottleneck.

The invention disclosed and claimed herein, in one aspect thereof, comprises a system that facilitates data management. The system includes a storage component that decentralizes data storage by storing data on a plurality of computing devices, and an access component that facilitates peer-to-peer access of the data from any one or more of the computing devices.

In another aspect of the subject invention, when a client requests a file the system automatically calculates all the locations of that file, and which is the quickest source to retrieve the file. The client then stores a copy of the file for instant retrieval later and to serve that file out to other clients that request it. A versioning scheme ensures that the only the newest version of files are shared on the network.

In yet another aspect thereof, a machine learning and reasoning (LR) component is provided that employs a probabilistic and/or statistical-based analysis to prognose or infer an action that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates data management in accordance with an innovative aspect.

FIG. 2 illustrates a methodology of transferring data during data management in accordance with an aspect.

FIG. 3 illustrates a methodology of retrieving data during data management in accordance with an aspect.

FIG. 4 illustrates a more detailed schematic block diagram of a system that facilitates data management in accordance with another aspect of the subject innovation.

FIG. 5 illustrates a methodology of prioritizing data for backup according to an aspect.

FIG. 6 illustrates a methodology of monitoring a system for failure and restoring data in accordance with the disclosed innovation.

FIG. 7 illustrates a methodology of updating data of other systems in accordance with a disclosed aspect.

FIG. 8 illustrates a methodology of restoring data from multiple other systems in accordance with an aspect.

FIG. 9 illustrates a methodology of restoring a software program that includes modules which can be restored from multiple different systems in accordance with an aspect.

FIG. 10 illustrates a system that employs a learning and reasoning (LR) component which facilitates automating one or more features in accordance with the subject innovation.

FIG. 11 illustrates a system that employs decentralized storage with multiple access paths in accordance with the subject innovation.

FIG. 12 illustrates a methodology of processing requests from multiple different systems in accordance with an aspect.

FIG. 13 illustrates a methodology of processing restore acknowledgments in accordance with a novel aspect.

FIG. 14 illustrates a methodology of updating backed up data based on the amount of change and/or criticality of the data to the system.

FIG. 15 illustrates a block diagram of a computer operable to execute the disclosed architecture.

FIG. 16 illustrates a schematic block diagram of an exemplary computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

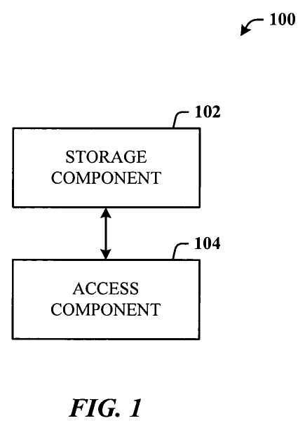

Referring initially to the drawings, FIG. 1 illustrates a system 100 that facilitates data management in accordance with an innovative aspect. The system 100 provides high availability (e.g., quick, robust, redundant, . . . ) data to a user by utilizing peer-to-peer technology, where the decentralized storage and multi-access paths provide a complete dataset without dependence on a specific or pre-defined data source or access paths. This includes sourcing data from one or more other users of the data by applying larger file transfer techniques and file sharing. Note that when referring to data, it is to be understood that this includes all forms and types of data and associated data formats such as in the form of a file, a document, a screen, a message, graphics, and multimedia information, for example.

By using peer-to-peer technology to distribute files, a number of benefits are realized in a distributed HMI (human-machine interface) system. Files are distributed for storage on many computers eliminating a single point of failure. Additionally, client call-up times of requested data are reduced as the peer-to-peer technology retrieves the data from the quickest source. Since the files can be are stored in many different locations, data transfer bottlenecks that can occur on a network (e.g., LAN, WAN, WLAN, . . . ) can be eliminated. Moreover, large files can be retrieved from multiple sources at the same time eliminating the single source bottleneck.

In one implementation, when a client requests a file, the system automatically calculates all storage locations of that file, and which is a quickest communications path to the source for retrieval the data and/or file. Once received, the client then stores a copy of the file for substantially instant service of that file to other requesting clients. A version scheme ensures that the only the latest version of file is shared on the network.

Accordingly, the system 100 includes a storage component 102 that decentralizes data storage by storing data on a plurality of computing devices. An access component 104 is provided that facilitates peer-to-peer access to the data via any one or more of the computing devices on which the data is stored. The system 100 can be implemented in the form of a software client that resides on computing systems available on the network.

The system 100 finds particular applicability to HMI systems where workstations are utilized to monitor and control process control systems and assembly line systems, for example. Continued reliable operation of these systems is important with regard to product reliability, product quality, product output, and a host of other cost and quality related aspects, to name just a few. These systems typically employ large files that are used to monitor and control various parameters, and so on. An operator sitting in front of a workstation overseeing a process (e.g., microelectronics device fabrication) can use many programs and graphical interface screens, etc., that are provided to view and monitor process operations. Conventionally, these files and/or data are stored on server. The subject invention distributes these files and/or data, process control screens, etc., to other computers for storage and access in case this workstation failed, or the files and/or data became corrupted.

For example, monitor and control screens that are used or accessed the most can be distributed more times than screens that are accessed fewer times. The more frequently accessed data and/or files can be stored (or backed up) on more reliable remote access nodes. Other criteria that can be considered include the speed at which data and/or file retrieval occurs from a given node and the pathways employed to retrieve the data/files.

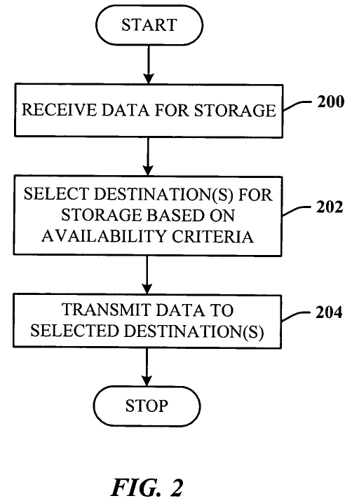

FIG. 2 illustrates a methodology of transferring data during data management in accordance with an aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. At 200, data is received for storage (or backup). At 202, one or more destinations are selected for storing the data, based on availability criteria. At 204, the data is transmitted to the selected destination(s) and stored.

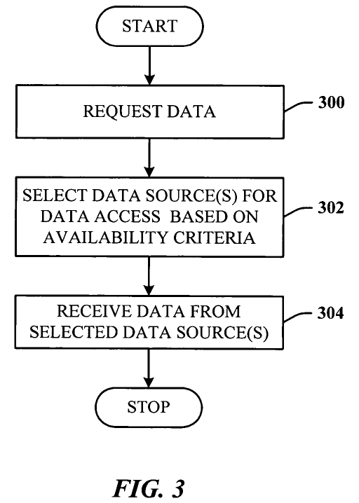

FIG. 3 illustrates a methodology of retrieving data during data management in accordance with an aspect. At 300, data is requested for retrieval. At 302, one or more data sources are selected for the retrieval process based on availability criteria. At 304, the data is retrieved from the selected data source(s).

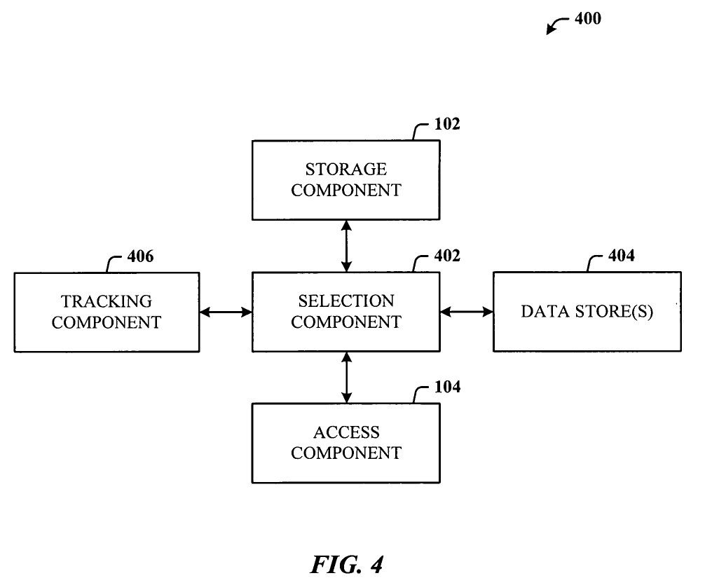

FIG. 4 illustrates a more detailed schematic block diagram of a system 400 that facilitates data management in accordance with another aspect of the subject innovation. The system 400 includes the storage component 102 and access component 104 of FIG. 1. Additionally, a selection component 402 is provided that interfaces to both the storage and access components (102 and 104) to provide selection capability for the most appropriate data stores 404 of the system 400. The selection component 402 operates based at least in part on the availability criteria such as the computing systems that are available to provide the requested data, the quickest (or highest bandwidth) path from the requesting computing device to the data source, and so on. It may be that a source computing system is online, yet cannot deliver the requested data since it is currently occupied by a high priority monitor and control process operation.

The system 400 also includes a tracking component 406 that tracks activities of the system 400. These activities can include both user and system activities. When a data distribution (or storage) process is to commence, or a data retrieval process is initiated, the selection component 402 accesses the tracking component 406 to analyze tracking data as to the data and/or files that are to be processed for storage and retrieval, the nodes that are available, and the best destination/source node to utilize, for example.

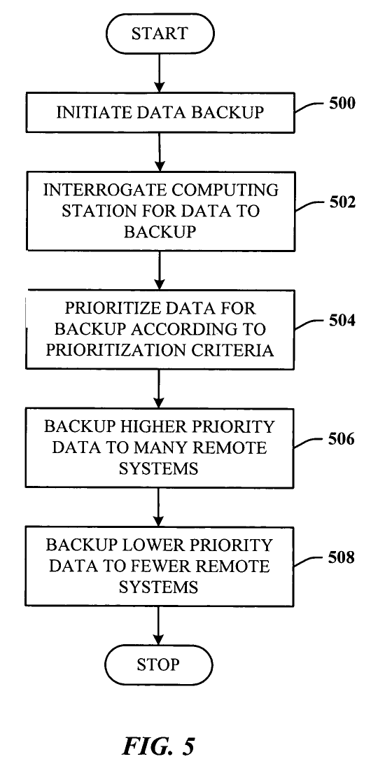

FIG. 5 illustrates a methodology of prioritizing data for backup according to an aspect. At 500, a backup process is initiated. At 502, an interrogation process is conducted on the computing system for data and/or files to backup. At 504, the data and/or files found are prioritized according to prioritization criteria. At 506, higher priority data is stored on many remote nodes. At 508, lower priority data and/or files are backed up on a fewer number of nodes.

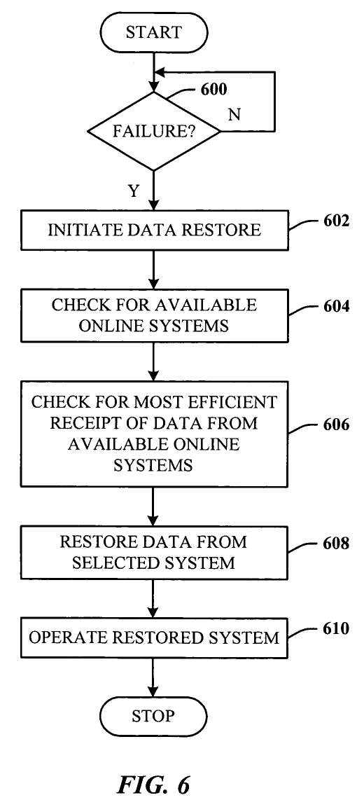

Referring now to FIG. 6, there is illustrated a methodology of monitoring a system for failure and restoring data in accordance with the disclosed innovation. At 600, the system monitors itself or another system for a failure. The failure can be in the form of a total system failure or a less radical failure such as data and/or file corruption. At 602, if no failure is detected, flow loops back to the input of 600 to continue monitoring for a failure. If a failure is detected, flow is from 600 to 602 to initiate a data restore operation. At 604, a check is made for online (or available) access nodes. At 606, a check is then made of the most efficient means for retrieving the data from the available nodes. At 608, once the node or nodes are selected, data is retrieved from the selected system(s), and restored to the failed system, now back online and operational. At 610, the restored system can then be operated.

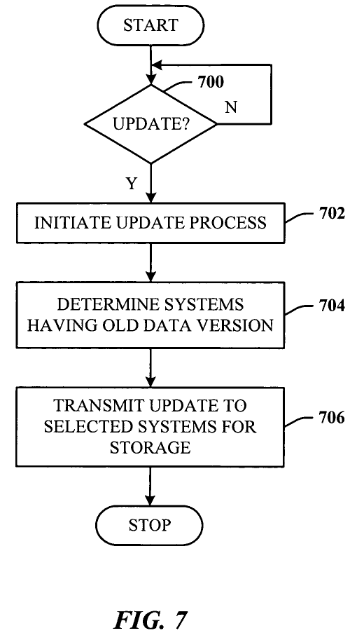

Referring now to FIG. 7, there is illustrated a methodology of updating data of other systems in accordance with a disclosed aspect. At 700, the system monitors itself or another system for updates. If no updates are detected, flow loops back to the input of 700 to continue monitoring for updates. If an update is detected, flow is from 700 to 702 to initiates an update process. At 704, the process can include checking which other systems hold data that needs to be updated with the latest version. At 706, once the appropriate systems are selected, the updated data is transmitted thereto, and the old data overwritten.

It is to be appreciated that not all updates are error-free, and can cause system faults or problems that are problematic. Thus, a latest update may need to be overwritten or downgraded to an earlier version that operates more error free. The “update” process can then include updating with an earlier and more stable version of data than the latest version.

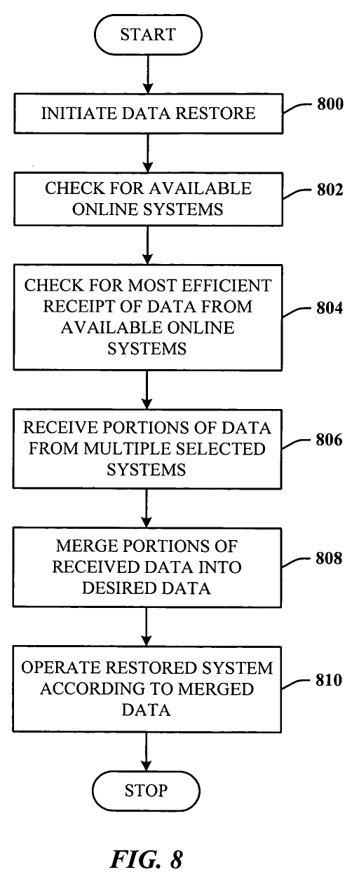

Referring now to FIG. 8, there is illustrated a methodology of restoring data from multiple other systems in accordance with an aspect. At 800, a data restore operation is initiated. At 802, a check is made for available systems. At 804, of the available systems, a check is made for the most efficient manner to receive the data from the available systems. Note that where all other systems are unavailable, this restoration process can include signaling an offline backup system to power-up, and then transmit the data therefrom to the system to be restored. At 806, if the most efficient manner is to receive the data from multiple available systems, a request for the data can be communicated to several nodes. At 808, once the data is received at the requesting system, a merge process can be conducted to merge all portions of the received data into the desired format to provide a complete dataset of the requested data. At 810, the system can then operate using the restored data.

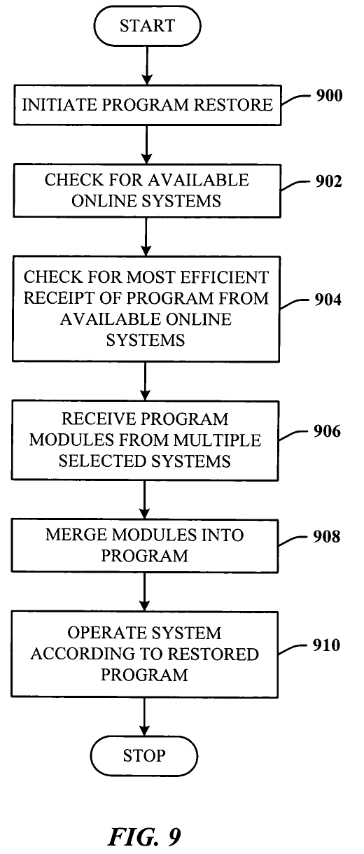

FIG. 9 illustrates a methodology of restoring a software program that includes modules which can be restored from multiple different systems in accordance with an aspect. At 900, a program restore operation is initiated. At 902, a check is made for available systems. At 904, of the available systems, a check is made for the most efficient manner to receive the program from the available systems. At 906, if the most efficient manner is to receive the program and/or program modules from multiple available systems, a request for the program can be communicated to several nodes. At 908, once the modules are received at the requesting system, a merge process can be conducted to merge all portions of the received program modules into the desired program to provide a complete operational program. At 910, the system can then operate using the restored program.

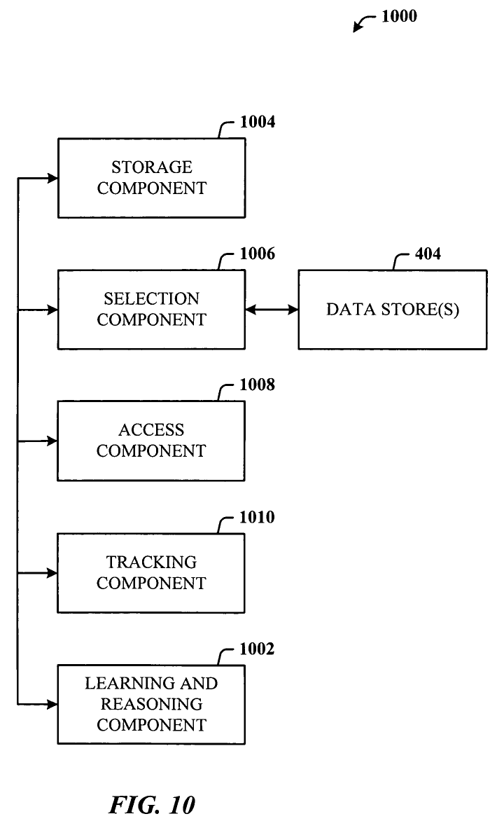

FIG. 10 illustrates a system 1000 that employs a learning and reasoning (LR) component 1002 which facilitates automating one or more features in accordance with the subject innovation. The system 1000 can further include a storage component 1004 that facilitates storage and of data to selected data stores 404 (or system(s)), a selection component 1006 that selects which available systems 404 are to be used for storing data and retrieving data, an access component 1008 that facilitates access to the available system(s) for retrieving data, and a tracking component 1010 that tracks information associated with where data has been stored, which systems are available, user interactions with the systems, the number of data interactions that occur for any given data, updates that are required, and many other similarly related aspects.

The subject invention (e.g., in connection with selection) can employ various LR-based schemes for carrying out various aspects thereof. For example, a process for determining when a file should be updated can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed. In the case of data systems, for example, attributes can be words or phrases or other data-specific attributes (e.g., data formats) derived from the words, and the classes are categories or areas of interest (e.g., levels of priorities).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions, including but not limited to assessing the best times at which a data restore and/or backup can be conducted, and estimating the cost at which a growing file will be best to backup rather than waiting to completion of the file change. The LR component 1002 can also track user and system interaction with screens and data, and based on this, prioritize the data for backup. This can also include backing the data up to systems will provide the fastest restore process. These prioritization criteria can also include system capabilities of all systems. For example, it would be preferred to back the most important large file data to a system that has larger processing capacity over a system that has limited processing capability. Similarly, it may be the more robust systems are employed for delicate process control operations, thus, it may not be desirable to backup data to such a system during a process operation, but to a lesser loaded machine at such time.

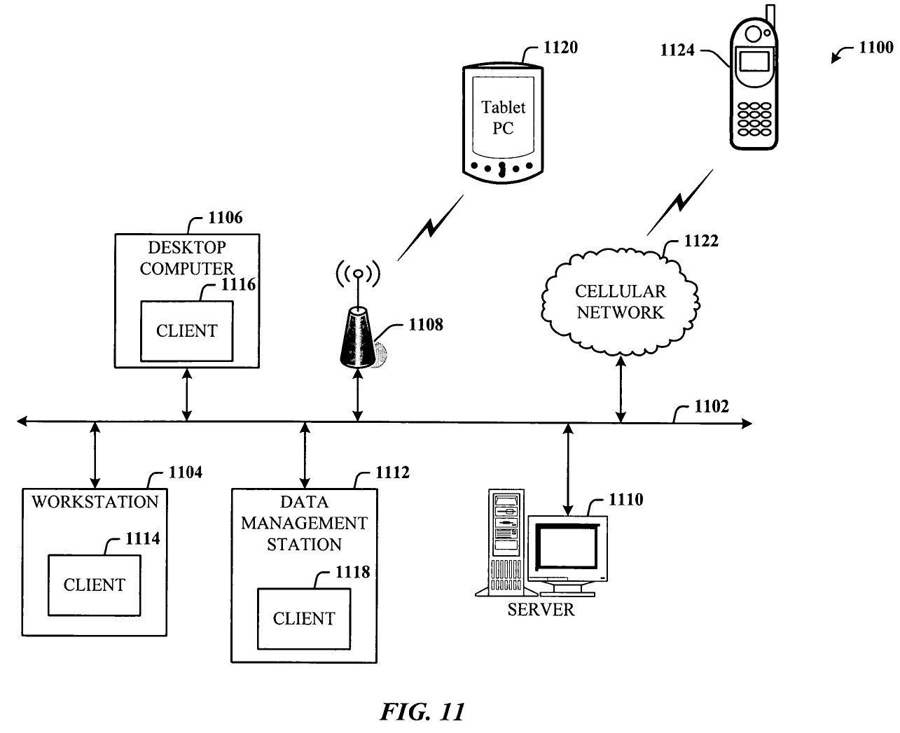

FIG. 11 illustrates a system 1100 that employs decentralized storage with multiple access paths in accordance with the subject innovation. The system 100 includes a network 1102 on which are disposed a number of access nodes: a workstation 1104, a desktop computing system 1106, a wireless access point 1108, a server 1110, and a data management station 1112. A number of the access nodes further include a client that facilitates data management for decentralized data backup and restore as described herein. For example, the workstation 1104 can include a workstation client 1114, the desktop computer 1106 can include a desktop client 1116, and the data management station 1112 can include a client 1118. The server 1110 need not include a client since data management can be accomplished by a remote station that includes a client.

The access point 1102 facilitates wireless communications to a wireless device (e.g., a tablet PC 1120) that can be used to store backup data. The wireless device can also include a client (not shown) that facilitates data restoration from other access nodes of the network 1102. The network 1102 can also interface to a cellular network 1122 in order to utilize a cellular device 1124 (e.g., a cell phone) as a backup system. Similarly, the cellular device 1124 can include a client (not shown) that facilitates data management in accordance with the subject invention.

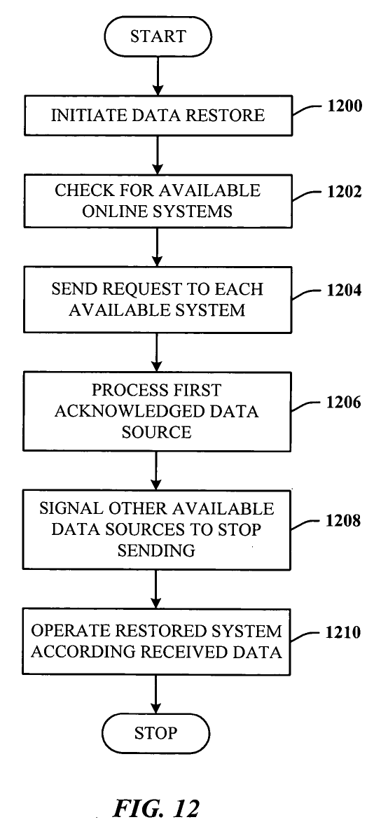

FIG. 12 illustrates a methodology of processing requests from multiple different systems in accordance with an aspect. At 1200, a data restore process is initiated. At 1202, a check for available systems is made. At 1204, a restore request is sent to each available system. At 1206, the requesting system begins to receive acknowledgments from the available systems. Once the first acknowledgment is received, the system can then signal the other systems to stop sending, as a way to more efficiently process the restore action, as indicated at 1208. At 1210, the restored system then operates according to the received data.

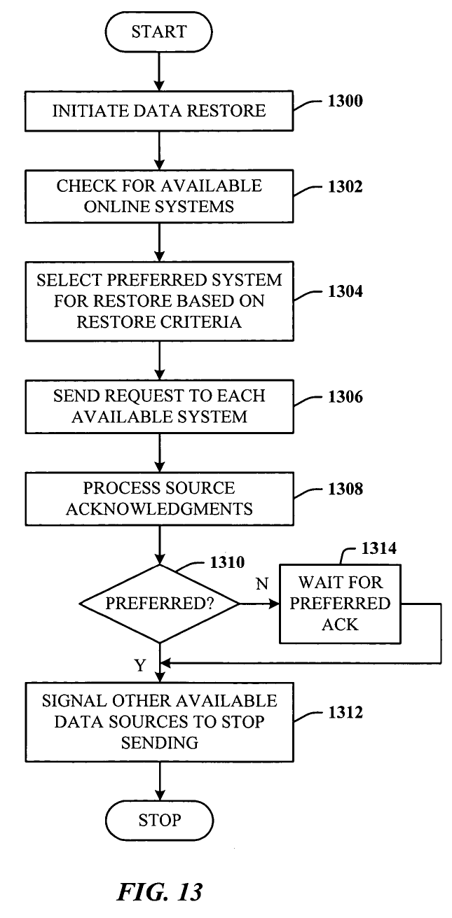

FIG. 13 illustrates a methodology of processing restore acknowledgments in accordance with a novel aspect. At 1300, a data restore process is initiated. At 1302, a check for available systems is made. At 1304, a preferred system for restoration is selected of the available systems. At 1306, a restore request is sent to each available system. At 1308, the requesting system begins to receive and process acknowledgments from the available systems. At 1310, the system determines if the received acknowledgment is from the preferred source. If so, at 1312, the receiving system signals the remaining systems to stop sending. If the received acknowledgment is not from the preferred source, flow is from 1310 to 1314 to ignore the acknowledgment and wait until the preferred system responds.

It is to be appreciated that this preferential processing can include not only the preferred system, but a second preferred system, a third preferred system, and so on. Thus, where a large file is involved, only the data retrieval will be conducted according to the preferred systems (e.g., only the first, second and third systems).

In either case, the system can perform calculations and estimations of the cost to wait for a preferred system or systems to respond versus the time and reliable pathways that could have been taken for alternative system(s) to respond sooner, and made decisions that would abort the preferred systems and utilize the lesser systems for the restore operation.

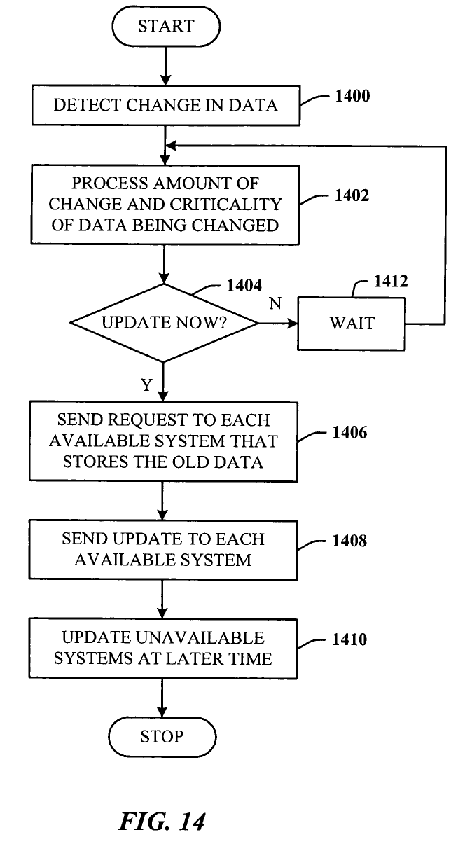

FIG. 14 illustrates a methodology of updating backed up data based on the amount of change and/or criticality of the data to the system. At 1400, a change in data I detected by the system. At 1402, the system processes this change to determine the amount of change and the value (or the criticality) of the data to the overall system and/or process operation. At 1404, if the amount of change and/or the value (or the criticality) of the data is deemed to be high, flow is to 1406 to send requests to the available systems that store the old data. At 1408, updated data is sent to each available system. For those systems that store the old version, but are offline or unavailable, the update process can be initiates to only those systems at a later time, as indicated at 1410. If, at 1404, the system determines not to update at this time, flow is to 1412 to wait until the amount of change reaches a level that warrants an update and/or backup process. Flow then proceeds back to 1402.

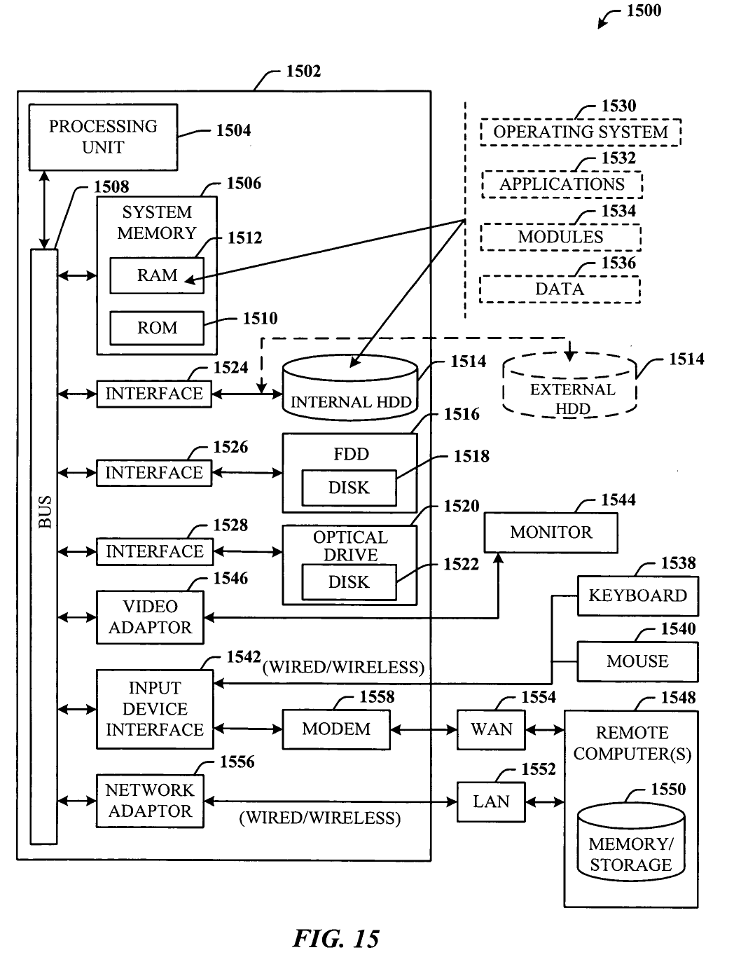

Referring now to FIG. 15, there is illustrated a block diagram of a computer operable to execute the disclosed architecture. In order to provide additional context for various aspects thereof, FIG. 15 and the following discussion are intended to provide a brief, general description of a suitable computing environment 1500 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 15, the exemplary environment 1500 for implementing various aspects includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is to be appreciated that the innovation can be implemented with various commercially available operating systems or combinations of operating systems.

A user can enter commands and information into the computer 1502 through one or more wired/wireless input devices, e.g., a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which may connect to a global communications network, e.g., the Internet.

When used in a LAN networking environment, the computer 1502 is connected to the local network 1552 through a wired and/or wireless communication network interface or adapter 1556. The adaptor 1556 may facilitate wired or wireless communication to the LAN 1552, which may also include a wireless access point disposed thereon for communicating with the wireless adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

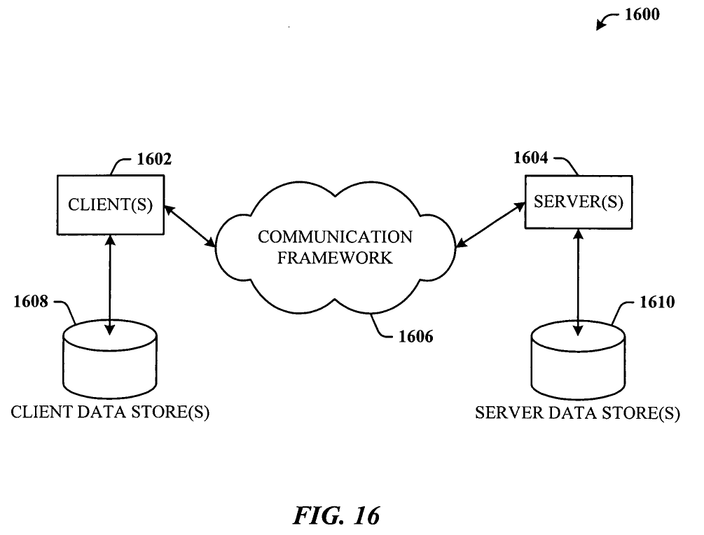

Referring now to FIG. 16, there is illustrated a schematic block diagram of an exemplary computing environment 1600 in accordance with another aspect. The system 1600 includes one or more client(s) 1602. The client(s) 1602 can be hardware and/or software (e.g., threads, processes, computing devices). The client(s) 1602 can house cookie(s) and/or associated contextual information by employing the subject innovation, for example.

The system 1600 also includes one or more server(s) 1604. The server(s) 1604 can also be hardware and/or software (e.g., threads, processes, computing devices). The servers 1604 can house threads to perform transformations by employing the invention, for example. One possible communication between a client 1602 and a server 1604 can be in the form of a data packet adapted to be transmitted between two or more computer processes. The data packet may include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates data management, comprising:
a storage component that decentralizes data storage by storing data on a plurality of computing devices; and
an access component that facilitates peer-to-peer access of the data from any one or more of the computing devices.

2. The system of claim 1, wherein the storage component stores the data based on a more frequently accessed criterion.

3. The system of claim 2, wherein the data that is more frequently accessed is stored on a computing system that allows retrieval faster than by other systems.

4. The system of claim 1, wherein the access component determines all computing device locations of the data and calculates which of the locations provides the quickest retrieval.

5. The system of claim 1, wherein the storage component facilitates updating data stored on the plurality of computing devices.

6. The system of claim 1, further comprising a tracking component that tracks changes in the data.

7. The system of claim 1, further comprising a selection component that selects the plurality of computing devices on which the data will be stored.

8. The system of claim 7, wherein the selection component selects the plurality of computing systems based on computing power and a capability to deliver requested data quickly.

9. The system of claim 1, wherein the access component facilitates retrieval of portions of the data from several different computing systems and the portions are merged together to form a complete dataset.

10. The system of claim 1, wherein a most frequently accessed data is stored on most of the plurality of computing devices that are available for the data storage.

11. The system of claim 10, wherein a computing device is available when it is online.

12. The system of claim 1, wherein a computing device is available when storage of the data thereto does not impact a process the computing device is monitoring and/or controlling.

13. The system of claim 1, wherein a data management station is disposed on a network, the data management station comprising the storage component and the access component.

14. The system of claim 1, wherein the storage component and the access component are provided as a software client.

15. The system of claim 1, further comprising a learning and reasoning component that employs a probabilistic and/or statistical-based analysis to prognose or infer an action that a user desires to be automatically performed.

16. A system that facilitates data management, comprising:
a storage component that decentralizes data storage by storing a file on multiple access nodes;
an access component that facilitates peer-to-peer access of the data from any of the multiple access nodes; and
a selection component that facilitates selection of an access node on which to store the file and an access node from which to retrieve the file based on availability of the access node.

17. The system of claim 16, wherein the storage component stores the file on a first access node based on a more frequently accessed criterion and retrieves the file from a second access node based on a fastest communications path.

18. The system of claim 16, wherein the access component determines all access node locations that store a copy of the file and calculates which of the access node locations provides the fastest retrieval of the file.

19. The system of claim 16, wherein the storage component facilitates updating the file stored on a second access node based on a change to the file on a first access node.

20. The system of claim 19, wherein the change is updated to the second access node only after the file reaches a certain file size on the first access node.

21. The system of claim 16, wherein the selection component selects an access node for storage based on computing power of the access node.

22. The system of claim 16, wherein the access component facilitates retrieval of a first portion of the file from a first access node and a second portion of the file from a second access node.

23. The system of claim 22, wherein the first portion of the file and the second portion of the file are merged to regenerate the file at a requesting access node.

24. The system of claim 16, wherein when the selection component requests retrieval of the file from the multiple access nodes, the selection component selects an access node that responds first to the request.

25. The system of claim 16, wherein when the selection component requests retrieval of the file from the multiple access nodes, the selection component selects an access node that responds after a first response to the request.

26. The system of claim 16, the file comprises at least one of a process control screen, process control data, trend data, and a software program.

27. A computer-implemented method of managing data, comprising:
selecting data for peer-to-peer backup on multiple access nodes based on data criteria;
checking for availability of the multiple access nodes based on availability criteria;
selecting a subset of the multiple access nodes on which to store the data; and
storing the data on the subset of access nodes.

28. The method of claim 27, wherein the data criteria includes a frequency at which the data is accessed.

29. The method of claim 27, further comprising an act of prioritizing multiple types of data based on importance and backing up a most important data on the subset of access nodes.

30. The method of claim 29, further comprising an act of backing up the most important data on an access node that has a fastest access times of the subset of access nodes.

31. The method of claim 27, further comprising an act of storing the data on available nodes of the subset of access nodes and storing the data at a later time on an unavailable node of the subset of access nodes when the unavailable node becomes available.

32. The method of claim 27, further comprising an act of tracking changes to the data and performing the act of storing when the data reaches a predetermined size.

33. The method of claim 27, further comprising acts of:
checking for a failed node of one of the multiple access nodes;
requesting a copy of the data during a restore process;
checking for availability of a subset of the multiple access nodes during the restore process;
retrieving the copy of the data to the failed node; and
operating the failed node according to the copy of the data.

34. The method of claim 33, wherein the act of requesting is performed to an access node that provides the fastest retrieval of the copy of the data.

35. The method of claim 33, wherein the copy of the data is retrieved in parts, each part obtained from a different access node.

36. The method of claim 33, wherein the failed node fails due to corrupted data.

37. The method of claim 33, further comprising an act of performing the restore process during an off-peak time.

38. The method of claim 33, further comprising an act of calculating which of the multiple access nodes provides the fasts communications path for retrieving the copy of the data.

39. A computer-executable system of managing data, comprising:
means for selecting data for peer-to-peer backup on multiple access nodes based on data criteria;
means for checking for availability of the multiple access nodes based on availability criteria;
means for selecting a subset of the multiple access nodes on which to store the data;
means for storing the data on the subset of access nodes;
means for checking for a failed node of one of the multiple access nodes;
means for requesting a copy of the data during a restore process;
means for checking for availability of a subset of the multiple access nodes during the restore process;
means for retrieving the copy of the data to the failed node; and
means for operating the failed node according to the copy of the data.
